(19) United States
(12) Patent Application Publication
(10) Pub. No.: US 2006/0046038 A1
(43) Pub. Date: Mar. 2, 2006

(54) Touch panel

(76) Inventors: Akira Nakanishi, Osaka (JP); Tetsuo Murakami, Osaka (JP); Shigeyuki Fujii, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/205,165

(22) Filed: Aug. 17, 2005

(30) Foreign Application Priority Data
Sep. 2, 2004 (JP) 2004-255212

(51) Int. Cl. B32B 7/02

(52) U.S. Cl. 428/212

(57) ABSTRACT

Provided is a dew condensation-free touch panel. Touch panel (200) has first transparent substrate (21) and second transparent substrate (22). First transparent substrate (21) has main surface (21a) provided with first transparent conductive film (23). Second transparent substrate (22) has main surface (22a) on which water vapor transmission preventive layer (40) as dew condensation prevention part, and second transparent conductive film (24) are provided in this order. Touch panel (200) has two regions: visible region (26a) and invisible region (26b) with region boundary (26) between them. Water vapor transmission preventive layer (40) is formed at least in visible region (26a). First transparent substrate (21) and second transparent substrate (22) are fixedly bonded to each other via adhesive layer (31) in invisible region (26b) or in the periphery of touch panel (200) so that first transparent conductive film (23) and second transparent conductive film (24) can have a predetermined distance therebetween.

### TECHNICAL FIELD

The present invention relates to a touch panel mounted in the input operation unit of different types of electronic devices. The invention more specifically relates to a touch panel mounted on the display surface side of liquid crystal display devices and the like so as to allow the user to input signals by touching certain positions on the display surface with a pen or finger.

### BACKGROUND ART

In recent years, mobile devices and electronic devices using a menu selection function have been provided with a touch panel which allows the user to input signals by touching certain positions on the display surface with a pen or finger.

There are several known types of touch panels. Of these, an analog resistive touch panel, which is the most commonly used, will be described as follows with reference to drawings. Note that in these drawings, the touch panels are enlarged in the thickness direction for the sake of convenience of illustration and for the sake of clarity of the touch panel.

FIG. 6 is a cross sectional view of a conventional touch panel. Touch panel 100 is provided with first transparent substrate 1 whose main surface 1a has first transparent conductive film 3 thereon which is about 200 Å thick and made of tin-doped indium oxide (hereinafter, ITO) or the like by, e.g. sputtering. First transparent substrate 1 is a glass plate or a resin sheet such as polycarbonate resin or acrylic resin, or could be a polymer film with excellent transparency such as a biaxially stretched polyethylene terephthalate film or a polycarbonate film.

On first transparent conductive film 3 and inside region boundary 6 or in visible region 6a, fine-sized dot spacers 5 made of insulating epoxy resin or the like are provided at a predetermined pitch.

When first transparent substrate 1 is made of flexible material such as film, other main surface 1b of the substrate may be reinforced by pasting thereon a resin sheet such as polycarbonate resin or acrylic resin, or a glass plate.

Touch panel 100 is provided, on the operation side, with second transparent substrate 2 which the user touches with a pen or finger. In general, second transparent substrate 2 is a transparent film of biaxially stretched polyethylene terephthalate, polycarbonate or cycloolefin. Second transparent substrate 2 has main surface 2a provided with second transparent conductive film 4 which is about 200 Å thick and made of ITO or the like by, e.g. sputtering.

In visible region 6a, first transparent conductive film 3 and second transparent conductive film 4 are opposed to each other with a predetermined distance between them. In order to keep this condition, first and second transparent substrates 1 and 2 are bonded to each other just like the periphery of a picture frame at the outside of region boundary 6, that is, in invisible region 6b.

Second transparent substrate 2 has other main surface 2b provided with hard coat layer 7 which is made of acrylic resin and which has a pencil hardness of 3 H so as to allow the user to touch with a pen or finger. Hard coat layer 7 protects other main surface 2b from scratches during the touch operation with a pen or finger.

Invisible region 6b includes wiring and electrodes (hereinafter, wiring/electrode patterns) 8 and 12 for supplying voltage to transparent conductive films 3 and 4; undercoat resists 9 and 13; overcoat resists 10 and 14; and adhesive layer 11 for bonding between first and second transparent substrates 1 and 2, all of which are formed in a predetermined pattern.

Wiring/electrode patterns 8 and 12 are formed by painting conductive paint containing a resin dispersed with silver powder, and then drying the paint to form a film. Resists 9, 13 and resists 10, 14 are provided to improve the insulation in the areas where the electric connection between wiring/electrode pattern 8 and wiring/electrode pattern 12 is unnecessary.

Note that in FIG. 6, wiring/electrode patterns 8 and 12 are respectively provided with undercoat resists 9 and 13 because main surface 1a of first transparent substrate 1 has first transparent conductive film 3 on its entire surface, and main surface 2a of second transparent substrate 2 has second transparent conductive film 4 on its entire surface. However, undercoat resists 9 and 13 are not necessarily necessary if first and second transparent conductive films 3 and 4 are etched to form a predetermined pattern so that the portions including the wire of wiring/electrode patterns 8, 12 that do not need electric connection can be out of contact with first and second transparent conductive films 3 and 4.

In general, invisible region 6b which looks like the periphery of a picture frame is formed by stacking resists 9, 10, 13 and 14, wiring/electrode patterns 8, 12, adhesive layer 11, etc. Therefore, in invisible region 6b, first and second transparent conductive films 3 and 4 have a spacing of about 80 to 300 μm between them. In visible region 6a, on the other hand, first transparent conductive film 3 and second transparent conductive film 4 may have a spacing smaller than 80 μm or larger than 300 μm between them in some parts due to warpage of first and second transparent substrates 1 and 2 or other reasons.

Touch panel 100 is further provided with flexible printed circuit (hereinafter, FPC) 15 which is fixedly bonded in order to transmit signals derived from first and second transparent conductive films 3 and 4 to an external circuit. FPC 15 has a tail which is to be mounted on different types of electronic devices and which is connected to the external circuit of a device (unillustrated).

In FPC 15, substrate film 16 has a plurality of wiring patterns 17 on one side thereof, and the intermediate and other portions of each of wiring patterns 17 that are unnecessary to be exposed are covered with cover lay 18. FPC 15 is thermocompression bonded to second transparent substrate 2 via anisotropic conductive film 19, and each of wiring patterns 17 is electrically connected with wiring/electrode patterns 8 and 12.

When using conventional touch panel 100 thus structured, the user touches a certain position on second transparent substrate 2 to cause the position to sag down. This makes first and second transparent conductive films 3 and 4 come into contact with each other at the areas corresponding to the touched position, which can be detected via FPC 15.

Prior art of the present invention is shown, e.g. in Japanese Patent Unexamined Publications Nos. H06-28098 and 2002-328779.

Such conventional touch panels use polymer film as second transparent substrate 2. This increases the water vapor transmission on the second transparent substrate 2 side, and when the touch panel is left for a long time under high temperature and high humidity conditions, the inner space of the touch panel, that is, the space formed between first and second transparent substrates 1 and 2 also has an air layer under high temperature and high humidity conditions. Later, if the touch panel is suddenly moved into low temperature and low humidity conditions, the touch panel suffers from dew condensation inside it.

Second transparent conductive film 4 formed on the main surface 2a side of second transparent substrate 2 is made of ITO, which is an inorganic compound. This means that second transparent conductive film 4 has the function of preventing water vapor transmission. However, the film thickness is generally about 200 Å in view of light transmission and electrical resistivity, so that the water vapor transmission rate compliant with JIS K 7129 or measured by MOCON method is about 0.3 g/(m²·day). The touch panel is subjected to a severe environmental test in which the touch panel is left for 240 hours under high temperature and high humidity conditions, e.g. 60° C. and 90%, and then suddenly moved to normal temperature and normal humidity conditions of, e.g. 25° C. and 60%. This test leads to the occurrence of dew condensation inside the touch panel, so that it is difficult to prevent water entry and dew condensation in the touch panel by second transparent conductive film 4 having the thickness of ITO only.

In general, the environment to use a touch panel does not have a sudden large change in the actual use. However, the results of this severe environmental test are extremely important because they affect the operational life and reliability of the touch panel.

The present invention, which solves this conventional problem, has an object of providing a touch panel which is more resistant to internal condensation.

### SUMMARY OF THE INVENTION

A touch panel of the present invention has a first transparent substrate and a second transparent substrate at least one of which is made of either a resin sheet or a polymer film. The first transparent substrate has a first transparent conductive film on a main surface thereof, and the second transparent substrate has a second transparent conductive film on a main surface thereof. The first and second transparent conductive films are opposed to each other with a predetermined distance therebetween. The first and second transparent conductive films have two regions: a visible region and an invisible region, and are fixedly bonded to each other in the invisible region. At least one of the first and second transparent conductive films is provided with a dew condensation prevention part in the visible region.

The provision of the dew condensation prevention part can prevent dew condensation particularly caused by changes in humidity conditions. For example, the touch panel of the present invention does not suffer from internal condensation even if it is moved suddenly from high temperature and high humidity conditions to low temperature and low humidity conditions.

The touch panel of the present invention protects itself from water entry by providing, as a dew condensation prevention part, a water vapor transmission preventive layer made of an inorganic compound either outside the first and/or second transparent conductive film that is made of the resin sheet or the polymer film, or between the first and/or second transparent substrate and the first and/or second transparent conductive film provided thereon.

In this structure, the at least one of the first and second transparent substrates that is made of the resin sheet or the polymer film is provided with a water vapor transmission preventive layer separate from the first and/or second transparent conductive film provided thereto, thereby reducing the water vapor transmission. This makes it harder for water vapor to enter the touch panel even under high temperature and high humidity conditions. As a result, the touch panel does not cause internal condensation even if it is moved suddenly from high temperature and high humidity conditions to low temperature and low humidity conditions.

In the touch panel of the present invention, the at least one of the first and second transparent substrates having the water vapor transmission preventive layer and the first transparent conductive film and/or the second transparent conductive film has a water vapor transmission rate of not more than 0.1 g/(m²·day) compliant with JIS K 7129 or measured by MOCON method. With the first and/or second transparent substrate having this specification, the touch panel can be resistant to internal condensation even if it is moved from higher temperature and higher humidity conditions to lower temperature and lower humidity conditions.

The touch panel of the present invention protects itself from water entry by providing as a dew condensation prevention part a polymer film or a resin sheet, which has thereon a water vapor transmission preventive layer of an inorganic compound, onto the at least one of the first and second transparent substrates that is made of the resin sheet or the polymer film at least in the visible region. This structure can make it harder for the touch panel to cause internal condensation even with a severe environmental change from high temperature and high humidity conditions to low temperature and low humidity conditions. This structure can also improve the yield and reduce the cost because the water vapor transmission preventive layer is formed onto the polymer film or the resin sheet which is separate from the at least one of the first and second transparent substrates and then pasted thereon later.

In the touch panel of the present invention, the polymer film or the resin sheet having thereon the water vapor transmission preventive layer has a water vapor transmission rate of not more than 0.1 g/(m²·day) compliant with JIS K 7129 or measured by MOCON method. The film or sheet with this specification can make it harder for the touch panel to cause internal condensation even if it is moved from higher temperature and higher humidity conditions to lower temperature and lower humidity conditions. This structure can also improve the yield and reduce the cost because the water vapor transmission preventive layer is formed onto the polymer film or the resin sheet which is separate from the at least one of the first and second transparent substrates and then pasted thereon later.

In the touch panel of the present invention, the inorganic compound contains at least one of silicon oxide, titanium oxide, indium oxide, tin oxide, zirconium oxide, ITO, aluminum oxide and silicon oxide nitride. These inorganic compounds have transparency excellent enough to have the same transparency as conventional touch panels, regardless of the provision of the water vapor transmission preventive layer, thereby making the touch panel of the present invention high quality.

In the touch panel of the present invention, the inorganic compound has an anti-reflective effect. Since the inorganic compound functions not only as the water vapor transmission preventive layer, but also as the anti-reflective layer, the touch panel can have better light transmission than in the conventional ones.

The touch panel of the present invention protects itself from water entry by a glass plate of not more than 1.5 mm thick, which is pasted as a dew condensation prevention part onto at least one of the first and second transparent substrates at least in the visible region. The use of the glass plate of not more than 1.5 mm thick can prevent the entry of water vapor, without decreasing the operability of the touch panel.

In the touch panel of the present invention, a polymer film having a hard coat layer thereon is pasted on a surface of the glass plate that is opposite to the surface which is pasted on the at least one of the first and second transparent substrates. The top and bottom surfaces of the glass plate are sandwiched between the resin members made of a resin sheet, a polymer film or the like. This structure reduces the chance of the glass plate shattering when the device is accidentally dropped. In addition, the hard coat layer formed on the polymer film can protect the polymer film from scratches during the touch operation.

In the touch panel of the present invention, the first and second transparent conductive films have a distance of 5 μm to 60 μm therebetween throughout the internal region of the touch panel where the first and second transparent substrates are bonded to each other via the adhesive layer. A decrease in the distance between the first and second transparent conductive films can reduce the amount of air contained at least in the visible region of the touch panel. This can prevent the touch panel from suffering from internal condensation.

As described hereinbefore, the present invention makes the touch panel more resistant to internal condensation even if the environment is changed suddenly from high temperature and high humidity conditions to low temperature and low humidity conditions, thereby keeping the visibility and operability of the touch panel at good levels. This prevents the touch panel from suffering from property degradation, thereby providing it with a longer life.

### BRIEF DESCRIPTION OF THE DRAWINGS

FIG. 1 is a top view of a touch panel according to a first embodiment of the present invention.

FIG. 2 is a cross sectional view taken along the line A-A shown in FIG. 1.

FIG. 3 is a cross sectional view of a touch panel according to a second embodiment of the present invention.

FIG. 4 is a cross sectional view of a touch panel according to a third embodiment of the present invention.

FIG. 5 is a cross sectional view of a touch panel according to a fourth embodiment of the present invention.

FIG. 6 is a cross sectional view of a conventional touch panel.

### DETAILED DESCRIPTION OF THE INVENTION

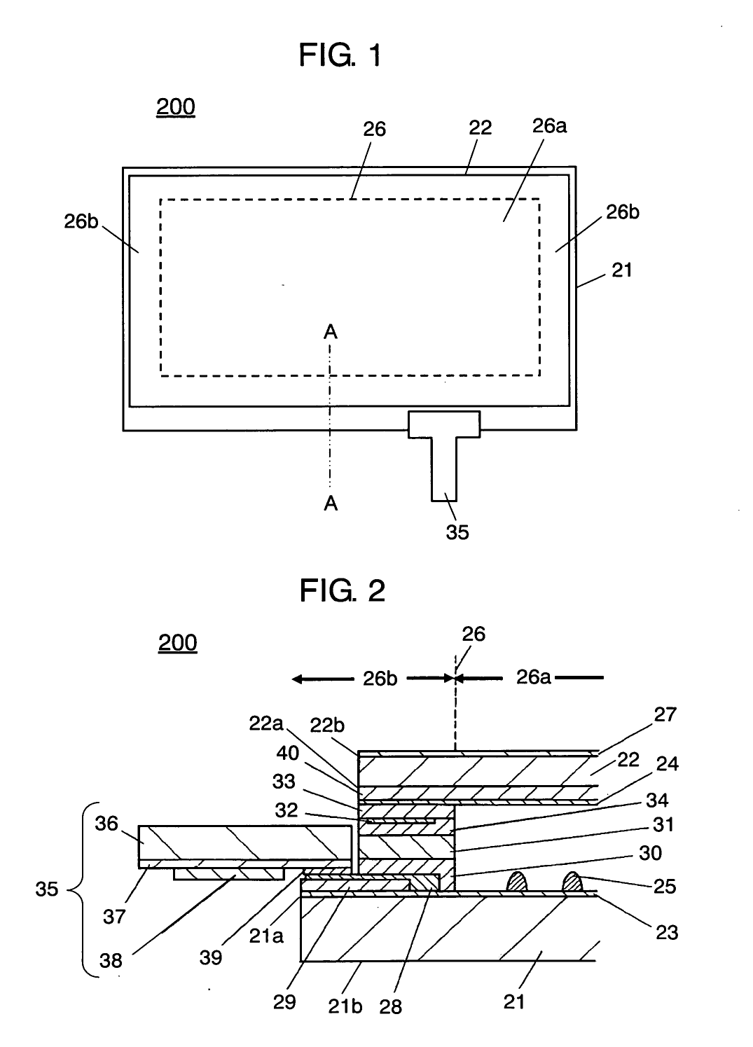

Embodiments of the present invention will be described as follows with reference to FIGS. 1 to 5. In these drawings, the touch panels are enlarged in the thickness direction, or in the up-and-down direction in the drawings for the sake of convenience of illustration and for the sake of clarity of the invention.

### First Embodiment

FIG. 1 is a top view of touch panel 200 of a first embodiment of the present invention, and FIG. 2 is a cross sectional view taken along the line A-A shown in FIG. 1.

Touch panel 200 is provided with first transparent substrate 21, second transparent substrate 22, region boundary 26, visible region 26a, invisible region 26b and flexible printed circuit 35. Region boundary 26 is the boundary between visible region 26a and invisible region 26b.

In FIG. 2, first transparent substrate 21 is made of soda glass and has main surface 21a fully covered with first transparent conductive film 23 made of ITO or the like. On first transparent conductive film 23 and in visible region 26a are provided fine-sized dot spacers 25 made of insulating epoxy resin or the like at a predetermined pitch.

Second transparent substrate 22 is placed on the operation side of touch panel 200 and is, e.g. 188 μm thick and made of a biaxially stretched polyethylene terephthalate film with flexibility. Second transparent substrate 22 has main surface 22a on which water vapor transmission preventive layer 40 of silicon oxide about 400 Å in thickness and second transparent conductive film 24 containing ITO about 200 Å in thickness are disposed in this order.

In visible region 26a, first and second transparent conductive films 23 and 24 are opposed to each other with a distance (spacing) of about 20 to 500 μm between them. This distance is determined in such a manner as to keep the insulation between these films in normal times, and also to make second transparent conductive film 24 come into contact with dot spacers 25 when second transparent substrate 22 is pressed towards first transparent substrate 21. In order to keep this spacing, first and second transparent substrates 21 and 22 are bonded to each other in invisible region 6b in such a manner as to be shaped like the periphery of a picture frame having a predetermined width.

Second transparent substrate 22 has other main surface 22b covered with hard coat layer 27 which is made of acrylic resin and has a pencil hardness of 3 H in order to protect other main surface 22b from scratches during the touch operation with a pen or finger.

Invisible region 6b is provided with wiring and electrodes (hereinafter, wiring/electrode patterns) 28 and 32 for supplying voltage to first and second transparent conductive films 23 and 24. Wiring/electrode patterns) 28 and 32 are formed by painting conductive paint containing a resin dispersed with silver powder, and then drying the paint to form a film. Wiring/electrode patterns 28 and 32 are coated with undercoat resists 29 and 33 respectively, and overcoat resists 30 and 34 respectively, which are formed in a predetermined pattern in order to secure the insulation in the areas where the electric connection between wiring/electrode pattern 28 and wiring/electrode pattern 32 is necessary.

Invisible region 26b is also provided with adhesive layer 31 for bonding first and second transparent substrates 21 and 22.

Touch panel 200 of the present invention is further provided with FPC 35 which transmits signals derived from first and second transparent conductive films 23 and 24 to an external circuit. In FPC 35, substrate film 36 made of polyimide has on one side thereof a plurality of wiring patterns 37 which are gold-plated copper foil. In each of wiring patterns 37, the portions that are unnecessary to be exposed are covered with cover lay 38 made of polyimide.

Each of wiring patterns 37 of FPC 35 is electrically connected with wiring/electrode patterns 28 and 32 via anisotropic conductive film 39.

A method for manufacturing the touch panel of the present embodiment will be described as follows with reference to FIG. 2. First of all, on main surface 21a of first transparent substrate 21, first transparent conductive film 23 containing ITO is formed by sputtering or the like.

On other main surface 22b of second transparent substrate 22, on the other hand, hard coat layer 27 is formed by applying a paint mainly composed of acrylic resin with a roll coater. On main surface 22a of second transparent substrate 22, silicon oxide is applied about as thick as 400 Å as water vapor transmission preventive layer 40 by sputtering or the like. Later, second transparent conductive film 24 made of ITO is formed on water vapor transmission preventive layer 40 by sputtering or the like.

Next, dot spacers 25 are printed on first transparent substrate 21 in visible region 26a.

Furthermore, undercoat resists 29, 33, wiring/electrode patterns 28,32, overcoat resists 30, 34, adhesive layer 31 and the like are screen printed in a predetermined pattern on first and second transparent substrates 21 and 22 in invisible region 26b.

After the formation of these layers, first transparent substrate 21 made of glass is scribed and cut in the size of the touch panel. Second transparent substrate 22, which is a polyethylene terephthalate film, is punched in the size of the touch panel.

Next, first and second transparent substrates 21 and 22 formed into the predetermined shapes are bonded to each other via adhesive layer 31 in invisible region 26b in such a manner that first and second transparent conductive films 23 and 24 are opposed to each other with a predetermined distance between them. Furthermore, a process of pressing the periphery is applied to improve the adhesiveness of invisible region 26b, and an aging process is applied to improve the surface smoothness. Later, FPC 35 is thermocompression bonded and fixed to the first transparent substrate 21 side via anisotropic conductive film 39.

This thermocompression allows each of wiring patterns 37 of FPC 35 to supply voltage to first and second transparent conductive films 23 and 24 via wiring/electrode patterns 28 and 32 so as to electrically connect these films.

Operations of the touch panel of the first embodiment will be described as follows with reference to FIG. 2. First of all, the user touches a certain position on the hard coat layer 27 on second transparent substrate 22 with a finger or pen. This causes second transparent substrate 22 to sag down around the touched position, thereby making first and second transparent conductive films 23 and 24 come into electrical contact with each other at the areas corresponding to the touched position. A voltage ratio at the contact point is derived via FPC 35 and detected by an unillustrated external circuit.

As described above, touch panel 200 is provided with water vapor transmission preventive layer 40 of silicon oxide about 400 Å in thickness between second transparent substrate 22 and second transparent conductive film 24. Second transparent substrate 22 provided thereon with water vapor transmission preventive layer 40 and second transparent conductive film 24 has a water vapor transmission rate of 0.01 g/(m²·day) compliant with JIS K 7129 or measured by MOCON method. Touch panel 200 with this structure and with this water vapor transmission rate is subjected to an environmental test in which the touch panel is left for 240 hours at, e.g. a temperature of 60° C. and a humidity of 90%, and then suddenly moved to normal temperature and normal humidity conditions of 25° C. and 60%. The test results are favorable with no signs of dew condensation inside touch panel 200. Providing that the water vapor transmission rate is not more than 0.01 g/(m²·day), it is possible in actual use to obtain a touch panel resistant to internal condensation. It has also been found out that the same effect can be obtained by thickening a transparent conductive film made of an inorganic compound layer instead of providing water vapor transmission preventive layer 40.

Water vapor transmission preventive layer 40 may be disposed on the other main surface 22b side of second transparent substrate 22. In this case, the uppermost layer of second transparent substrate 22 is preferably protected by hard coat layer 27. In other words, water vapor transmission preventive layer 40 is preferably disposed between other main surface 22b of second transparent substrate 22 and hard coat layer 27.

Controlling the refractive index of water vapor transmission preventive layer 40 can reduce the light reflection rate of the ITO surface. It has been found out that when water vapor transmission preventive layer 40 is made of silicon oxide with a refractive index of 1.4, a film thickness of about 800 to 1000 Å can reduce the light reflection rate of the ITO surface, and second transparent substrate 22 provided thereon with water vapor transmission preventive layer 40 and second transparent conductive film 24 can have as high a total light transmission as about 91%. Second transparent substrate 22 with this specification is preferable because it can offer water vapor transmission preventive layer 40 with an anti-reflective effect. It has also been found out that when a touch panel is formed by combining second transparent substrate 22 having this specification with first transparent substrate 21 which is made of glass and which has first transparent conductive film 23 thereon and a total light transmission of 94%, the touch panel has a total light transmission of about 86%. This can obtain a touch panel having a higher total light transmission than in the case with no provision of water vapor transmission preventive layer 40 where the total light transmission is 83%.

As described hereinbefore, the touch panel of the first embodiment has water vapor transmission preventive layer 40 on second transparent substrate 22 made of a polymer film. This structure enables the touch panel to endure the severe environmental test in which the touch panel is moved suddenly from high temperature and high humidity conditions to low temperature and low humidity conditions, without the occurrence of internal condensation. This offers the touch panel of the present invention with excellent visibility and operability, thereby allowing it to be mounted on different types of electronic devices.

First transparent substrate 21 can be made of polycarbonate resin, methacryl resin, polycycloolefin resin, polycyclohexadiene resin, norbornene resin or the like, besides soda glass mentioned above. To mold these materials, general extrusion molding, casting molding, and injection molding can be used. It is also possible to use a resin sheet formed by injection molding, or a polymer film such as a biaxially stretched polyester film or a polycarbonate film. The thicknesses of the sheet and film can be 0.1 to 10 mm, and preferably 0.15 to 3 mm for practical use.

In the case where first transparent substrate 21 is made of a biaxially stretched polyester film, a polycarbonate film or another film, it is possible to apply glass, polycarbonate resin, methacryl resin, polycycloolefin resin, polycyclohexadiene resin, norbornene resin or the like on other main surface 21b, which is opposite to main surface 21a having first transparent conductive film 23 thereon. To mold these materials, general extrusion molding, casting molding, or injection molding can be used. It is also possible to paste a resin sheet formed by injection molding as a support member on other main surface 21b.

In the case where first transparent substrate 21 is made of a resin sheet or a polymer film, it is preferable to provide a water vapor transmission preventive layer to first transparent substrate 21 in addition to second transparent substrate 22. In this case, a silicon oxide film may be disposed either between main surface 21a of first transparent substrate 21 and first transparent conductive film 23 or on the other main surface 21b side of first transparent substrate 21.

Besides biaxially stretched polyethylene terephthalate, second transparent substrate 22 can be made of other stretched films such as biaxially stretched polyethylene naphthalate and uniaxially stretched polyethylene terephthalate. In addition to these materials, polycarbonate, polycycloolefin and the like formed by casting can be used. The film thicknesses can be 0.01 to 0.4 mm, and preferably 0.025 to 0.2 mm in practical use.

First and second transparent conductive films 23 and 24 may be made of a thin film of tin oxide (SnO2), zinc oxide (ZnO), gold (Au) or silver (Ag), besides ITO. To form these films, CVD (Chemical Vapor Deposition), vacuum deposition, ion plating and coating/sintering of metal organic material can be used, besides sputtering.

Besides silicon oxide, water vapor transmission preventive layer 40 can be a layer composed of at least one of the following inorganic compounds: titanium oxide, indium oxide, tin oxide, zirconium oxide, ITO, aluminum oxide and silicon oxide nitride. The appropriate thicknesses of these inorganic compound layers can be determined by taking the frequency of occurrence of pinholes or water vapor transmission rate into consideration. In view of these conditions, when silicon oxide, titanium oxide or aluminum oxide is used for water vapor transmission preventive layer 40, the thickness is preferably not less than 200 Å, and more preferably 300 to 2000 Å. When indium oxide, tin oxide, zirconium oxide, or ITO is used, the thickness is preferably not less than 300 Å, and more preferably 400 to 1200 Å. In the case of silicon oxide nitride, the thickness is preferably not less than 200 Å, and more preferably 250 to 1200 Å. The water vapor transmission rate is preferably not more than 0.1 g/(m²·day), and more preferably 0.001 to 0.03 g/(m²·day).

With a thickness smaller than the above ranges, these films suffer from pinholes, making the water vapor transmission rate not less than 0.1 g/(m²·day), which is far from the desirable level. On the other hand, with a thickness larger than the above ranges, the inorganic compound films increase in internal stress, or decrease in adhesion or light transmission. Therefore, it is important to make the film thickness within the predetermined range.

To form water vapor transmission preventive layer 40, besides sputtering mentioned above, it is possible to use plasma CVD (Chemical Vapor Deposition), electron beam vacuum deposition, or other methods capable of forming as dense a film as possible suitable for the water vapor transmission prevention material.

Undercoat resists 29, 33 and overcoat resists 30, 34 can be one or a combination of epoxy resin, acrylic resin, polyester resin, urethane resin and phenol resin. In any case, it is important to select materials that can be well bonded to the surfaces on which to print the resists.

Wiring/electrode patterns 28 and 32 may use, as conductive powder, a mixture of silver powder and carbon powder, copper powder, gold powder or the like besides a combination of silver powder and polyester resin. The resin constituent can be selected from those which belong to epoxy, phenol, acrylic and urethane resins, and which are excellent in electric resistance, adhesion, dispersion of conductive powder, anti-environmental characteristics and the like.

The formation of undercoat resists 29, 33, overcoat resists 30, 34, wiring/electrode patterns 28, 32 and adhesive layer 31 can be done by offset printing or the like, or ink coating such as ink pattern coating with a plotting head. Adhesive layer 31 may be formed by applying an adhesive double coated tape processed in a pattern.

Substrate film 36 and cover lay 38 of FPC 35 can be polyethylene terephthalate. Wiring patterns 37 may be a gold- or solder-plated copper foil or formed by painting conductive paint containing a resin dispersed with silver powder or the like, and then drying the paint to form a film.

Anisotropic conductive film 39 may be mainly composed of acrylic resin, gold- or solder-plated resin beads, ceramic beads or metal particles, besides epoxy resin.

### Second Embodiment

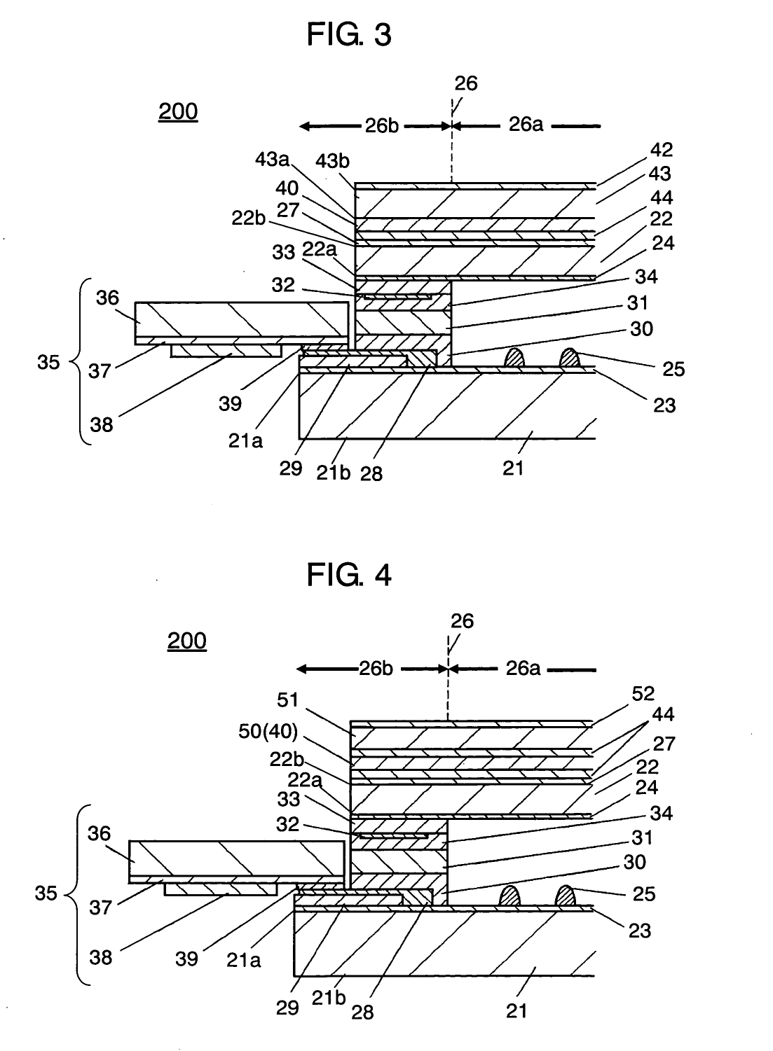

FIG. 3 is a cross sectional view of a touch panel of a second embodiment of the present invention. The same components as those in the first embodiment will be referred to with the same reference marks as those in the first embodiment and will not be described again in detail.

The touch panel of the second embodiment is identical to the touch panel of the first embodiment in that water vapor transmission preventive layer 40 is disposed on the second transparent substrate 22 side, which is made of polymer film, but is different in the arrangement.

More specifically, as shown in FIG. 3, second transparent substrate 22 of the second embodiment has second transparent conductive film 24 on main surface 22a thereof, and hard coat layer 27 on other main surface 22b thereof. On the other hand, water vapor transmission preventive layer 40 is formed on polymer film 43 which is a polymer film other than second transparent substrate 22. Then, polymer film 43 is pasted on other main surface 22b of second transparent substrate 22 via adhesive layer 44, thereby providing water vapor transmission preventive layer 40 on the second transparent substrate 22 side.

Polymer film 43 is made of biaxially stretched polyethylene terephthalate. Main surface 43a of polymer film 43 has water vapor transmission preventive layer 40 formed by sputtering 1000 Å-thick silicon oxide nitride, which is an inorganic compound. Other main surface 43b of polymer film 43 has hard coat layer 42 made of acrylic resin.

On the other main surface 22b side of second transparent substrate 22 at least in visible region 26a, polymer film 43 having water vapor transmission preventive layer 40 thereon is disposed above second transparent substrate 22 via adhesive layer 44.

The remaining structure is identical to that of the first embodiment, and its description will be omitted. Polymer film 43 having water vapor transmission preventive layer 40 of silicon oxide nitride thereon is bonded to second transparent substrate 22 having second transparent conductive film 24 and the like thereon. Water vapor transmission preventive layer 40 has a water vapor transmission rate of 0.003 g/(m²·day) compliant with JIS K 7129 or measured by MOCON method. Touch panel 200 thus prepared is subjected to a severe environmental test in which the touch panel is left for 240 hours at a temperature of 60° C. and a humidity of 90%, and then suddenly moved to normal temperature and normal humidity conditions of 25° C. and 60%. The test results indicate a better outcome than in the first embodiment, with no signs of dew condensation inside touch panel 200. Touch panel 200 is then subjected to a more severe environmental test in which it is left for 240 hours at a temperature of 70° C. and a humidity of 95%. As a result, the same favorable results as in the case where the touch panel is left for 240 hours at a temperature of 60° C. and a humidity of 90% can be obtained.

As in the first embodiment, water vapor transmission preventive layer 40 formed on polymer film 43 may be at least one or a combination of silicon oxide, titanium oxide, indium oxide, tin oxide, zirconium oxide, ITO and aluminum oxide, besides silicon oxide nitride. The film thickness, forming process and other conditions may be the same as those in the first embodiment.

As described hereinbefore, the touch panel of the second embodiment is provided with water vapor transmission preventive layer 40 or a dew condensation prevention part on polymer film 43 which is a polymer film other than second transparent substrate 22. In other words, unlike the touch panel of the first embodiment having a dew condensation prevention part integrated thereinto, the touch panel of the second embodiment is a combination of the conventional touch panel and a polymer film provided with a dew condensation prevention part. This touch panel can be formed by pasting non-defective units of both to each other, thereby improving the yield and reducing the cost. Preparing several dew condensation prevention part different in structure and properties to be provided on the polymer film 43 side allows the manufacture of different types of touch panels having different types of dew condensation prevention part, thereby expanding the use of touch panels.

Polymer film 43 may be a polycarbonate film, a polyolefin film, a triacetylcellulose film or the like besides a biaxially stretched polyethylene terephthalate film, or can be replaced by a resin sheet.

In the case where first transparent substrate 21 is made of resin, polymer film 43 having water vapor transmission preventive layer 40 thereon can be pasted on other main surface 21b of first transparent substrate 21 at least on visible region 26a to obtain the same effects.

Adhesive layer 44 may be either directly coated on water vapor transmission preventive layer 40 provided on main surface 43a of polymer film 43 or formed of an acrylic adhesive double coated tape.

### Third Embodiment

FIG. 4 is a cross sectional view of a touch panel of a third embodiment of the present invention.

The same components as those in the second embodiment will be referred to with the same reference marks as those in the second embodiment and will not be described again in detail.

The touch panel of the third embodiment is identical to the touch panel of the second embodiment in that water vapor transmission preventive layer 40 is disposed on the other main surface 22b side of second transparent substrate 22 made of polymer film, but is different in the arrangement. As shown in FIG. 4, second transparent substrate 22 has second transparent conductive film 24 on main surface 22a, and hard coat layer 27 on other main surface 22b as in the second embodiment.

The touch panel of the third embodiment is further provided with 0.2 mm-thick glass plate 50, which functions as water vapor transmission preventive layer 40 and is pasted via adhesive layer 44 on the other main surface 22b side of second transparent substrate 22.

Glass plate 50 has polymer film 51 which is made of biaxially stretched polyethylene terephthalate and is pasted thereon via adhesive layer 44. Polymer film 51 has hard coat layer 52 of acrylic resin formed on a top surface thereof, or the operation surface.

Then, glass plate 50 is pasted to second transparent substrate 22 via adhesive layer 44 and hard coat layer 27.

In this structure, the top and bottom surfaces of glass plate 50 are sandwiched between polymer film 51 and second transparent substrate 22 made of polymer film. This can reduce the chance of glass plate 50 shattering when the device is accidentally dropped.

A pasted combination of glass plate 50 functioning as water vapor transmission preventive layer 40 and second transparent substrate 22 having second transparent conductive film 24 and the like thereon is checked for its water vapor transmission rate compliant with JIS K 7129 or measured by MOCON method to obtain a value of about 0 g/(m²·day). Touch panel 200 thus prepared is subjected to a severe environmental test in which the touch panel is left for 240 hours at a temperature of 60° C. and a humidity of 90%, and then suddenly moved to normal temperature and normal humidity conditions of 25° C. and 60%. The test results are favorable with no signs of dew condensation inside touch panel 200. Touch panel 200 is subjected to another severe environmental test in which it is left for 240 hours at high temperature and high humidity conditions of 85° C. and 85%, and then suddenly moved to the normal temperature and normal humidity conditions. This test also shows favorable results.

As described hereinbefore, the touch panel of the third embodiment endures the severe environmental test in which it is moved suddenly from high temperature and high humidity conditions to normal temperature and normal humidity conditions, without the occurrence of dew condensation inside it. The touch panel of the present invention could surely provide favorable test results from even a more severe environmental test.

In the case where glass plate 50 as water vapor transmission preventive layer 40 is formed on the operation surface of the touch panel as in the aforementioned structure, glass plate 50 can be not more than 1.5 mm in thickness so as not to disturb smooth operation of the touch panel. For the purpose of reducing the touch panel in weight, glass plate 50 preferably has a thickness not more than 1.0 mm.

Besides the aforementioned structure, it is possible not to provide polymer film 51. In this case, glass plate 50 can be covered with a hard coat layer of acrylic resin to make the surface antiglare.

In the case where first transparent substrate 21 is made of resin, as in the second embodiment, glass plate 50 and polymer film 51 can be disposed on the first transparent substrate 21 side.

### Fourth Embodiment

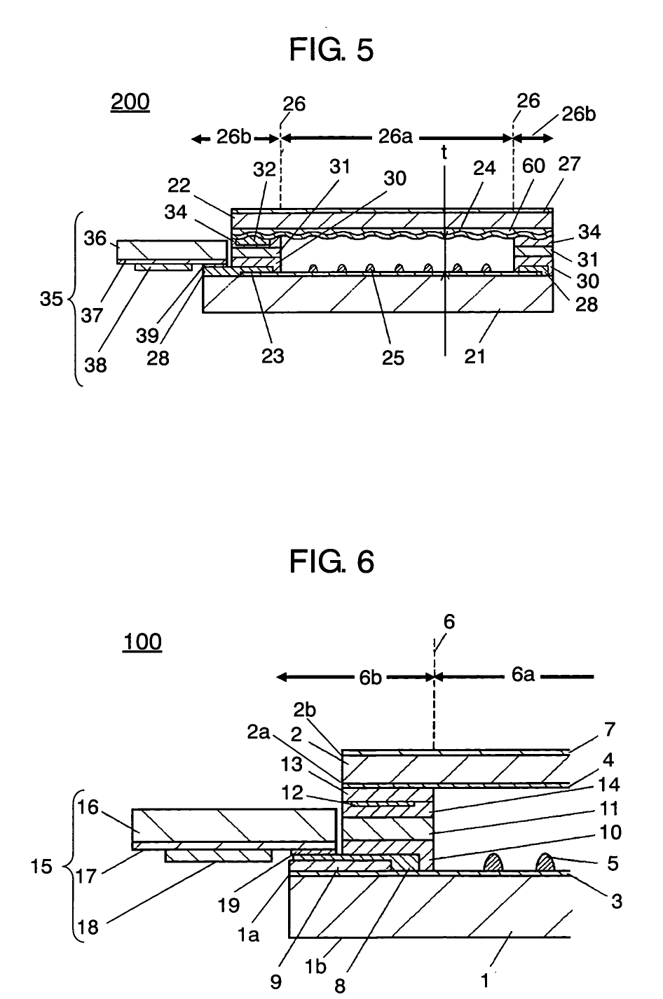

FIG. 5 is a cross sectional view of a touch panel of a fourth embodiment of the present invention. As shown in FIG. 5, touch panel 200 has nearly the same structure as the conventional touch panel, but is different in that the spacing between first and second transparent conductive films 23 and 24 is reduced. The same components as those in the first embodiment will be referred to with the same reference marks as those in the first embodiment and will not be described again in detail.

In order to reduce the spacing between first and second transparent conductive films 23 and 24, the touch panel is so structured that no undercoat resist is necessary on first transparent substrate 21 or second transparent substrate 22. To achieve this structure, patterning is performed in such a manner that first and second transparent conductive films 23 and 24 are etched except for their center parts. This results in the formation of wiring/electrode patterns 28 and 32 with a thickness of about 8 μm. In addition, 10 μm-thick overcoat resists 30 and 34 with excellent insulation are provided. Adhesive layer 31 is made of acrylic adhesive and has a thickness of 10 μm, instead of using an adhesive tape.

In this structure, first and second transparent conductive films 23 and 24 are etched so that the spacing “t” between the opposed surfaces of first and second transparent conductive film 23 and 24 in the vertical direction can be not more than 46 μm at least inside region boundary 26, that is, at least throughout visible region 26a.

The structure of the touch panel of the fourth embodiment does not have the water vapor transmission preventive layer of the first to third embodiments. Therefore, second transparent substrate 22 provided with second transparent conductive film 24 has a water vapor transmission rate of 0.3 g/(m²·day) compliant with JIS K 7129 or measured by MOCON method. The touch panel is subjected to a severe environmental test in which the touch panel is left for 240 hours at a temperature of 60° C. and a humidity of 90%, and then suddenly moved to normal temperature and normal humidity conditions of 25° C. and 60%. The test results indicate no signs of dew condensation inside the touch panel.

A reason for the favorable test results is assumed to be that the amount of air inside region boundary 26 of the touch panel, that is, in visible region 26a is too little to cause dew condensation.

The spacing “t” between first and second transparent conductive films 23 and 24 in visible region 26a can be about 60 μm to obtain similar effects. In order to secure the insulation stability between these films, the spacing “t” must be not less than 5 μm in view of environmental changes and the like.

As shown in FIG. 5, it is advantageous to provide rough surface layer 60 made of resin between second transparent conductive film 24 and second transparent substrate 22. This is because the roughness of rough surface layer 60 hinders the growth of water nuclei during condensation even if there is a large and sudden change in temperature or humidity, thereby preventing dew condensation.

Another reason for the favorable test results is that the reduced spacing “t” between first and second transparent conductive films 23 and 24 as compared with the spacing in the conventional touch panel stimulates the occurrence of Newton rings.

To make the surface roughness effective, rough surface layer 600 should have a surface roughness (Rz) of 0.01 to 50 μm compliant with JIS B 0601. With a surface roughness of not more than 0.01 μm, the effects of preventing dew condensation and Newton ring cannot be fully exerted. With a surface roughness of not less than 50 μm, the surface has so much haze that the display elements under touch panel 200 become blurry.

The water vapor transmission preventive layer of the first to third embodiments is provided to the touch panel of the fourth embodiment. Then, the touch panel is subjected to a severe environmental test in which it is left for 240 hours either at a temperature of 60° C. and a humidity of 90% or at a temperature of 85° C. and a humidity of 85%, and then suddenly moved to normal temperature and normal humidity conditions of 25° C. and 60%. The test results show no signs of dew condensation inside the touch panel, thereby indicating that the touch panel could be used under even more severe environmental conditions.

### INDUSTRIAL APPLICABILITY

The touch panel of the present invention is provided with a dew condensation prevention part at least in the visible region. This can keep the touch panel condensation-free even if it is moved suddenly from high temperature and high humidity conditions to low temperature and low humidity conditions. As a result, the touch panel maintains excellent visibility and operability. Thus, the touch panel of the present invention, which is useful as an input operation unit of different types of electronic devices, has high industrial applicability.

1. A touch panel comprising:
a first transparent substrate and a second transparent substrate each having a main surface and another main surface, at least one of the first transparent substrate and the second transparent substrate being made of one of a resin sheet and a polymer film;
a first transparent conductive film formed on a main surface side of the first transparent substrate; and
a second transparent conductive film formed on a main surface side of the second transparent substrate, wherein
the first transparent conductive film and the second transparent conductive film have a visible region and an invisible region, and are fixedly bonded to each other in the invisible region in such a manner as to be opposed to each other with a predetermined distance therebetween, and
one of the main surface and the other main surface of at least one of the first transparent substrate and the second transparent substrate is provided with a dew condensation prevention part in the visible region.

2. The touch panel according to claim 1, wherein
the dew condensation prevention part is a water vapor transmission preventive layer made of an inorganic compound.

3. The touch panel according to claim 2, wherein
the at least one of the first transparent substrate and the second transparent substrate, which is provided with the water vapor transmission preventive layer and the first transparent conductive film and/or the second transparent conductive film, has a water vapor transmission rate of not more than 0.1 g/(m²·day) compliant with JIS K 7129 or measured by MOCON method.

4. The touch panel according to claim 1, wherein
the dew condensation prevention part is one of a polymer film and a resin sheet having thereon a water vapor transmission preventive layer made of an inorganic compound, the dew condensation prevention part being provided at least in the visible region.

5. The touch panel according to claim 4, wherein
one of the polymer film and the resin sheet having thereon the water vapor transmission preventive layer has a water vapor transmission rate of not more than 0.1 g/(m²·day) compliant with JIS K 7129 or measured by MOCON method.

6. The touch panel according to claim 2, wherein
the inorganic compound contains at least one of silicon oxide, titanium oxide, indium oxide, tin oxide, zirconium oxide, ITO, aluminum oxide and silicon oxide nitride.

7. The touch panel according to claim 6, wherein
the inorganic compound has an anti-reflective effect.

8. The touch panel according to claim 1, wherein
the dew condensation prevention part is a glass plate of not more than 1.5 mm thick, which is provided on at least one of the first transparent substrate and the second transparent substrate at least in the visible region.

9. The touch panel according to claim 8, wherein
the glass plate is provided on a surface thereof with a polymer film having a hard coat layer thereon, the surface being opposite to a surface that is pasted on the at least one of the first transparent substrate and the second transparent substrate.

10. The touch panel according to claim 1, wherein
the first transparent conductive film and the second transparent conductive film have a distance of 5 μm to 60 μm therebetween in the visible region.

11. The touch panel according to claim 4, wherein
the inorganic compound contains at least one of silicon oxide, titanium oxide, indium oxide, tin oxide, zirconium oxide, ITO, aluminum oxide and silicon oxide nitride.
